(19) United States
(12) Patent Application Publication
(10) Pub. No.: US 2017/0116559 A1
(43) Pub. Date: Apr. 27, 2017

(54) Memory Optimizing Manager

(71) Applicants: Nicholas Chin, San Clemente, CA (US); Hannah Reed, San Clemente, CA (US); Mikayla Hartigan, San Clemente, CA (US); Lance Woodstra, San Clemente, CA (US); Lauren Woodstra, San Clemente, CA (US)

(72) Inventors: Nicholas Chin, San Clemente, CA (US); Hannah Reed, San Clemente, CA (US); Mikayla Hartigan, San Clemente, CA (US); Lance Woodstra, San Clemente, CA (US); Lauren Woodstra, San Clemente, CA (US)

(21) Appl. No.: 15/081,527

(22) Filed: Mar. 25, 2016

Related U.S. Application Data
(60) Provisional application No. 62/245,907, filed on Oct. 23, 2015.

(51) Int. Cl. G06Q 10/06; H04W 4/02

(52) U.S. Cl. CPC G06Q 10/063114; H04W 4/02

(57) ABSTRACT

One embodiment of the disclosure is related to an apparatus, method, and system for reminding a user to perform a task. The operations comprise: receiving user input indicative of a new reminder item comprising a preset time associated with the task; transmitting a signal indicative of the preset time associated with the task to a second device; receiving a signal indicative of either task completion or task failure from the second device; and transmitting a message indicative of either task completion or task failure consistent with the signal to a predetermined recipient.

### CROSS-REFERENCE TO RELATED APPLICATION

This application claims the benefit of priority from U.S. Provisional Patent Application Ser. No. 62/245,907, filed Oct. 23, 2015, entitled, “MEMORY OPTIMIZING MANAGER,” which is herein incorporated by reference.

### FIELD

Embodiments of the disclosure are related to electronic devices, and more particularly, to a set of electronic devices with which an enhanced method for reminding a user to perform a task is implemented.

### BACKGROUNDS

On computers, smartphones, and other programmable computing devices, reminder programs that remind a user at a preset time that a particular task should be performed are ubiquitous. However, the user may simply dismiss the reminder program when prompted to perform the task without actually performing it for various reasons. For example, the task to be performed may require the user to move to a different location, while the user may be unwilling or unable to move. As another example, the user may get distracted at the preset time by other events and not actually perform the task.

### SUMMARY

One embodiment of the disclosure is related to a method for reminding a user to perform a task implemented at a first device, comprising: receiving user input indicative of a new reminder item comprising a preset time associated with the task; transmitting a signal indicative of the preset time associated with the task to a second device; receiving a signal indicative of either task completion or task failure from the second device; and transmitting a message indicative of either task completion or task failure consistent with the signal to a predetermined recipient.

Another embodiment of the disclosure is related to a method for reminding a user to perform a task implemented at a second device, comprising: receiving a signal indicative of a new reminder item comprising a preset time associated with the task from a first device; determining whether a user mechanical input component is actuated within a predetermined time period after the preset time, wherein an actuation of the user mechanical input component within the predetermined time period indicates task completion, and an absence of actuation of the user mechanical input component within the predetermined time period indicates task failure; and transmitting a signal indicative of either task completion or task failure based on the determination to the first device, wherein the second device is placed at or near a location where the task is to be performed before the preset time.

Yet another embodiment of the disclosure is related to a method for reminding a user to perform a task implemented at a third device, comprising: receiving a signal indicative of a new reminder item comprising a preset time associated with the task from a first device; providing a notification to the user when the preset time has arrived; and determining whether a signal indicative of task completion has been received from a second device, wherein the notification is turned off in response to determining that the signal indicative of task completion has been received from the second device, and wherein the third device is carried around by the user.

### BRIEF DESCRIPTION OF THE DRAWINGS

FIG. 1 is a diagram illustrating an example environment in which embodiments of the disclosure may be practiced.

FIG. 2 is a diagram illustrating an example first device with which embodiments of the disclosure may be practiced.

FIG. 3 is a diagram illustrating an example second device with which embodiments of the disclosure may be practiced.

FIG. 4 is a diagram illustrating an example third device with which embodiments of the disclosure may be practiced.

FIG. 5 is a flowchart illustrating an example method for reminding a user to perform a task.

FIG. 6 is a flowchart illustrating an example method for reminding a user to perform a task.

FIG. 7 is a flowchart illustrating an example method for reminding a user to perform a task.

### DETAILED DESCRIPTION

Embodiments of the disclosure are related to a method for reminding a user to perform a task with a set of different electronic devices. In another aspect, embodiments of the disclosure may be related to a first device, one or more second devices, and optionally one or more third devices.

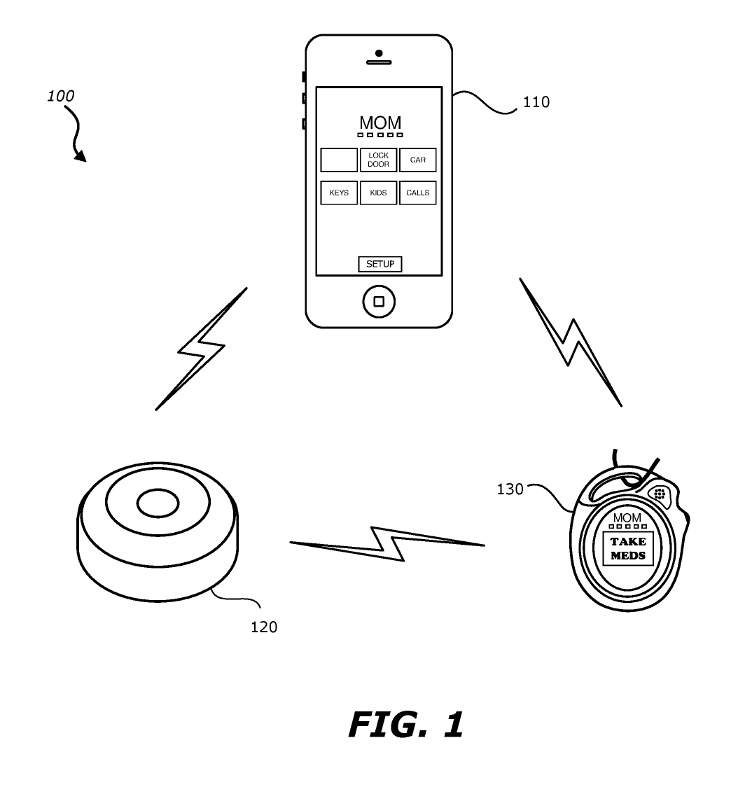

Referring to FIG. 1, a diagram illustrating an example environment 100 in which embodiments of the disclosure may be practiced is shown. It should be appreciated that the appearances of the devices in FIG. 1 are illustrative and do not limit the disclosure. The first device 110 may be a programmable computing device, such as a computer, a tablet, or a smartphone, that may be used to receive a user input indicative of a reminder item comprising at least a preset time in the future associated with a task and an identifier of a second device 120. The user input may also be generated by a third party other than the user that is going to perform the task. The reminder item may further comprise without limitation, e.g., a description of the task to be performed at the preset time, and/or a location where the task is to be performed. The task may be associated with a task identifier which uniquely identifies the task across all the devices described hereinafter. In one embodiment, the task is to take a medicine, and a barcode may be scanned to obtain a description of the medicine. In another embodiment, the user input may be a voice command, and voice recognition technologies may be utilized at the first device 110 to derive the reminder item based on the voice command. The first device 110 may transmit the preset time to the identified second device 120, which is a portable device, based on the identifier of the second device 120, preferably wirelessly with such protocols as Bluetooth, IEEE 802.11 wireless local area network (WLAN), wireless wide area network (WWAN) such as a cellular network, etc. The second device 120 may comprise a user mechanical input component, such as a push-button switch, or a touch sensor (either resistive or capacitive). The second device 120 may further comprise e.g., a sound-generating component, such as a speaker or a buzzer, and/or a light-emitting component, such as one or more light bulbs or light-emitting diodes (LEDs). The second device 120 is to be placed at or near the location where the task is to be performed before the preset time. For example, the task may be to take a medicine at the preset time, and the second device 120 may be placed near the medicine. When the preset time arrives, the user needs to physically actuate the user mechanical input component of the second device 120, such as by touching the touch sensor or pushing the push-button switch, in order to confirm the completion of the task. In one embodiment, the mechanical input has to persist for a predetermined time period, e.g., 5 seconds, for it to be registered by the second device 120. The second device 120 may generate a sound, such as a continual buzz sound or a voice read-out of the description of the task to be performed and/or the location where the task is to be performed, with its sound-generating component and/or may emit light, e.g., in a flashing pattern, with its light-emitting component when the preset time has arrived in order to attract the user's attention. When the task completion is confirmed by the user physically actuating the user mechanical input component of the second device 120, the second device 120 may transmit a signal indicative of task completion to the first device 110, thereby dismissing the reminder item. Further, once task completion is confirmed, the first device 110 may turn off the sound and/or the light. On the other hand, if the second device 120 cannot detect any user mechanical input after a predetermined time period, e.g., 5 minutes, has elapsed since the preset time, the second device 120 may accordingly transmit a signal indicative of task failure to the first device 110. The first device 110 may further transmit a message indicating either task completion or task failure to a predetermined recipient, such as a caretaker or a doctor, based on the signal received from the second device 120. The message from the first device 110 may be repeated a predetermined times, e.g., 3 times.

In another embodiment, in addition to the second device 120, a third device 230 may be utilized. After receiving the user input to set up the reminder item, the first device 110 may transmit the preset time to the third device 230, preferably wirelessly using such protocols as Bluetooth, IEEE 802.11 WLAN, or WWAN. Additionally, the first device 110 may also transmit the description of the task to be performed at the preset time, and/or the location where the task is to be performed to the third device 230. The third device 230 may be a portable device that is carried around by a particular user, such as a necklace pendant. Therefore, the third device 230 is associated with a particular user, and the identifier of the third device 230 need not necessarily be included with the creation of every new reminder item. The third device 230 may comprise a display component, such as a liquid crystal display (LCD), and/or a sound-generating component, such as a speaker or a buzzer, and/or a light-emitting component, such as one or more light bulbs or LEDs, and/or a vibration component, such as a vibration motor. When the preset time has arrived, the third device 230 may textually and/or graphically display with the display component the description of the task to be performed and/or the location where the task is to be performed in order to notify the user. Additionally or alternatively, the third device 230 may generate a sound, such as a continual buzz sound or a voice read-out of the description of the task to be performed and/or the location where the task is to be performed with its sound-generating component in order to notify the user. Additionally or alternatively, the third device 230 may emit light, e.g., in a flashing pattern, with its light-emitting component in order to notify the user. Additionally or alternatively, the third device 230 may vibrate by activating the vibration component in order to notify the user. When the task completion is confirmed at the second device 120, the second device 120 may wirelessly transmit a signal indicative of task completion to the third device 230. In response to the signal, the third device 230 may turn off the sound and/or light, and may turn off the display or start the display of the reminder item that is coming up, if there is one.

In a further embodiment, the third device 130 may further comprise an emergency user input component, such as a touch sensor, a push-button switch, etc., for receiving an emergency call request from a user. The user may actuate or otherwise engage the emergency user input component when there is an emergency. When the emergency user input component is engaged, the third device 130 may send an emergency signal to the first device 110, which may relay the emergency signal to a predetermined recipient, such as a caretaker or an emergency response center. As the third device 130 is associated with a particular user, the predetermined recipient may be able to identify and locate the user that initiated the emergency call. In some embodiments, the third device 130 may also send the emergency signal directly to the predetermined recipient.

Therefore, with more second devices 120, more reminder items may be simultaneously scheduled: each reminder item requires at least one second device 120. The different second devices 120 may be placed at different locations for different tasks. With more third devices 230, more users may be supported: each user requires at least one third device 230, if a third device 230 is to be used.

It should be appreciated that any wireless communication between any two devices in the environment 100 may be conducted directly or may be relayed through one or more other devices.

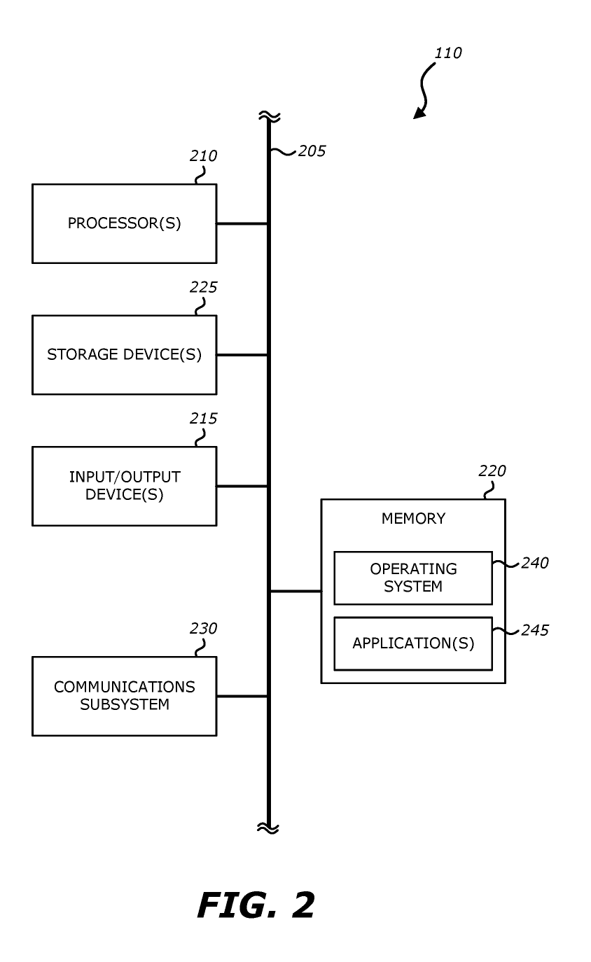

Referring to FIG. 2, a diagram illustrating an example first device 110 adapted for reminding a user to perform a task is shown. The first device 110 is shown comprising hardware elements that can be electrically coupled via a bus 205 (or may otherwise be in communication, as appropriate). The hardware elements may include one or more processors 210, including without limitation one or more general-purpose processors and/or one or more special-purpose processors (such as digital signal processing chips, graphics acceleration processors, and/or the like); one or more input/output devices 215, a mouse, a keyboard, a speaker, a printer, and/or the like.

The first device 110 may further include (and/or be in communication with) one or more non-transitory storage devices 225, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The first device 110 might also include a communication subsystem 230, which can include without limitation a modem, a network card (wireless or wired), an infrared communication device, a wireless communication device and/or chipset (such as a Bluetooth device, an IEEE 802.11 device, a Wi-Fi device, a WiMAX device, WWAN cellular communication facilities, etc.), and/or the like. The communications subsystem 230 may permit data to be exchanged with a network, other computer systems/devices, and/or any other devices described herein. In many embodiments, the first device 110 will further comprise a working memory 220, which can include a RAM or ROM device, as described above.

The first device 110 also can comprise software elements, shown as being currently located within the working memory 220, including an operating system 240, device drivers, executable libraries, and/or other code, such as one or more application programs 245, which may comprise or may be designed to implement methods, and/or configure systems, provided by other embodiments, as described herein. Merely by way of example, one or more procedures described with respect to the method(s) discussed below might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 225 described above. In some cases, the storage medium might be incorporated within a computer device, such as the first device 110. In other embodiments, the storage medium might be separate from a computer device (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the first device 110 and/or might take the form of source and/or installable code, which, upon compilation and/or installation on the first device 110 (e.g., using any of a variety of generally available compilers, installation programs, compression/decompression utilities, etc.), then takes the form of executable code.

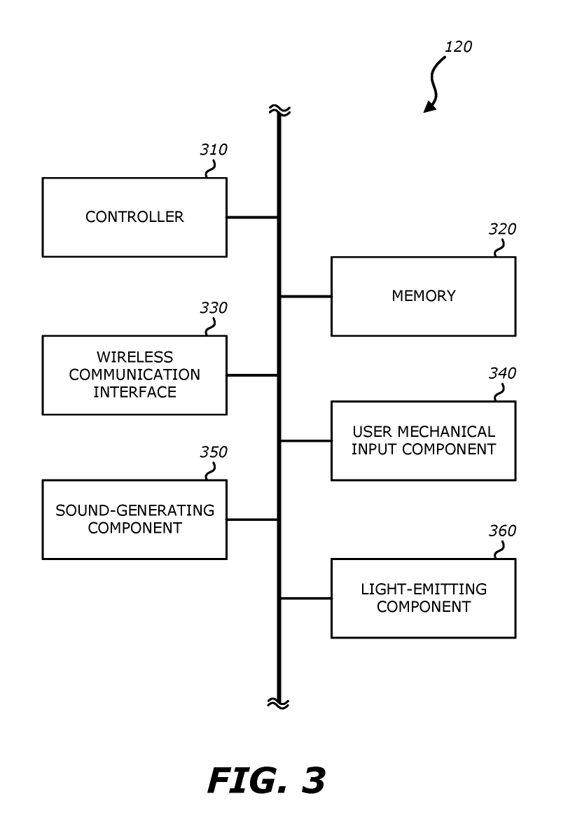

Referring to FIG. 3, a diagram illustrating an example second device 120 is shown. The second device is associated with an identifier, such as a hardware identification, or a network address, etc. The second device 120 may include without limitation a controller 310 and a memory 320. The operations of the second device 120 may be coordinated by the controller 310. The controller 310 may include a clock/timer (not shown) that keeps the current time, which may be synchronized through communication with other devices, such as the first device 110. A wireless communication interface 330 may enable the second device 120 to wirelessly communicate with other devices including the first device 110 and the third device 130 using such protocols as Bluetooth, IEEE 802.11 WLAN, or WWAN, etc. A user mechanical input component 340 may be deployed in the second device 120. The user mechanical input component 340 may be, e.g., a push-button switch or a touch sensor (either resistive or capacitive). A user may confirm the completion of a task by physically actuating the user mechanical input component 340. The second device 120 may further include without limitation a sound-generating component 350 and/or a light-emitting component 360. The sound-generating component 350 may be, for example, a buzzer or a speaker. The light-emitting component 360 may comprise, for example, one or more light bulbs or LEDs. The sound-generating component 350 and/or light-emitting component 360 may be activated to generate sound and/or emit light in order to attract the attention of the user.

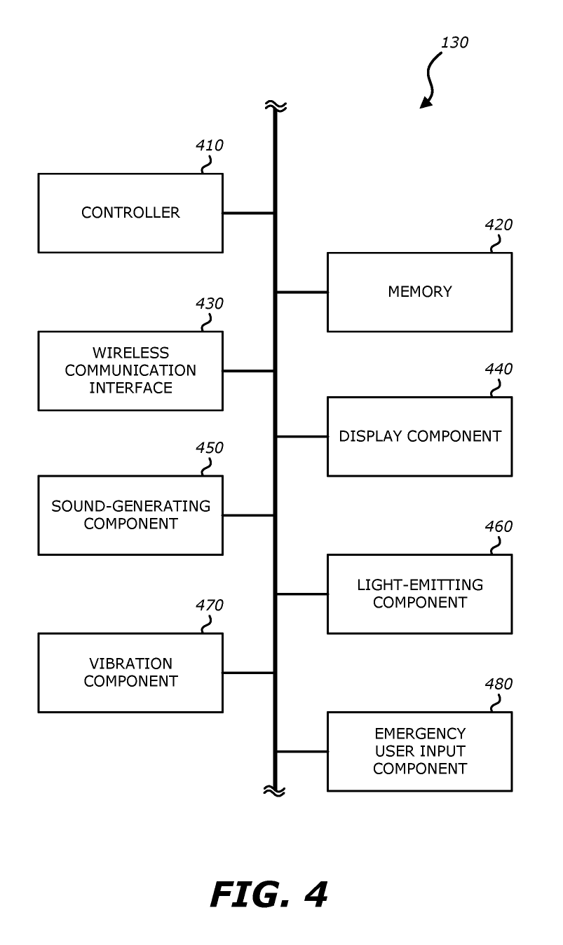

Referring to FIG. 4, a diagram illustrating an example third device 130 is shown. The third device 130 may be associated with an identifier, such as a hardware identification or a network address, etc. The third device may include without limitation a controller 410 and a memory 420. The operations of the third device 130 may be coordinated by the controller 410. The controller 410 may include a clock/timer (not shown) that keeps the current time, which may be synchronized through communication with other devices, such as the first device 110. A wireless communication interface 430 may enable the third device 130 to wirelessly communicate with other devices including the first device 110 and the second device 120 using such protocols as Bluetooth, IEEE 802.11 WLAN, or WWAN, etc. The third device 130 may further include without limitation a display component 440, a sound-generating component 450, a light-emitting component 460, and/or a vibration component 470. The display component 440 may be, for example, an LCD. The sound-generating component 450 may be, for example, a buzzer or a speaker. The light-emitting component 460 may comprise, for example, one or more light bulbs or LEDs. The vibration component 470 may comprise, for example, a vibration motor. A description of the task or a location where the task is to be performed may be textually and/or graphically displayed using the display component 440. The sound-generating component 450 and/or light-emitting component 460 may be activated to generate sound and/or emit light in order to provide a notification to the user. The vibration component 470 may be activated to vibrate the third device 130 to provide a notification to the user.

In some embodiments, the third device 130 may further comprise an emergency user input component 480. The emergency user input component 480 may be, for example, a touch sensor or a push-button switch, etc. In an emergency, a user may engage the emergency user input component 480 by e.g., push down on the touch sensor or push down the push-button switch. When the emergency user input component 480 is engaged, the third device 130 may transmit an emergency signal to a predetermined recipient, either directly or through a relay by the first device 110. The predetermined recipient may be, for example, a caretaker or an emergency response center. As the third device 130 is associated with a particular user, the caretaker or emergency response personnel may identify and locate the user that initiated the emergency call.

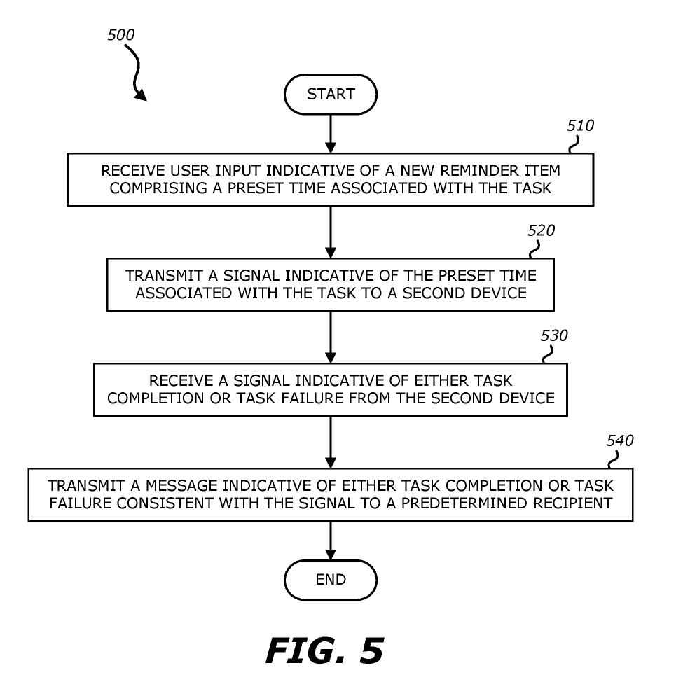

Referring to FIG. 5, a flowchart illustrating an example method 500 for reminding a user to perform a task is shown. The method 500 may be implemented at a first device 110. At block 510, user input indicative of a new reminder item comprising a preset time associated with the task may be received. The new reminder item may include an identifier of a second device 120, and may further include a description of the task to be performed at the preset time and/or a location where the task is to be performed. The user input may also be generated by a third party other than the user that is going to perform the task. At block 520, a signal indicative of the preset time associated with the task may be transmitted to the second device 120. The second device 120 may be identified with its identifier. The description of the task to be performed and/or the location where the task is to be performed may also be transmitted to the second device 120, if available. The information transmitted to the second device 120 may also be transmitted to a third device 130. At block 530, a signal indicative of either task completion or task failure may be received from the second device 120. In response to a signal indicative of task completion, the corresponding reminder item may be dismissed. If no signal is received after a predetermined period of time has elapsed since the preset time, task failure may be assumed. In some embodiments, the first device 110 may query the second device 120 one or more times in order to receive the signal indicative of the status of the task. At block 540, a message indicative of either task completion or task failure consistent with the signal may be transmitted to a predetermined recipient. The recipient may be, for example, a caretaker or a doctor.

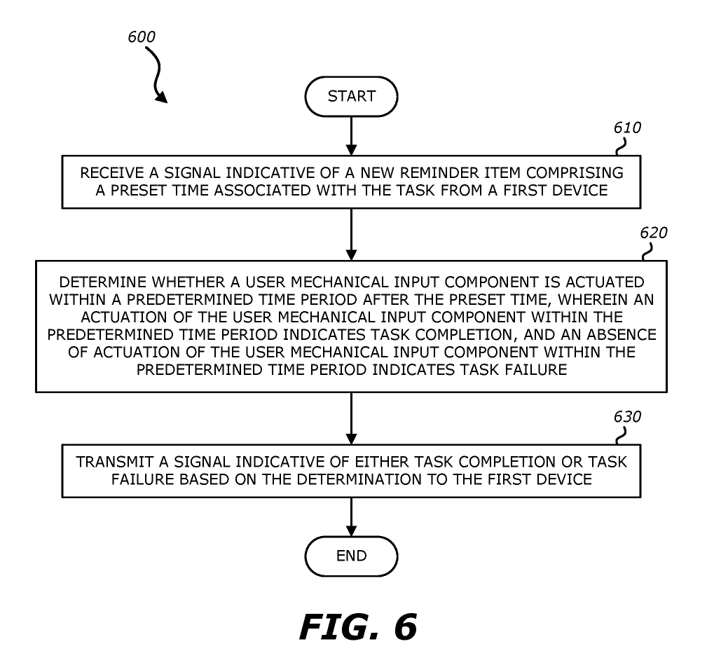

Referring to FIG. 6, a flowchart illustrating an example method 600 for reminding a user to perform a task is shown. The method 600 may be implemented at a second device 120. At block 610, a signal indicative of a new reminder item comprising a preset time associated with the task may be received from a first device 110. A description of the task to be performed at the preset time and/or a location where the task is to be performed may also be included in the new reminder item. The second device 120 should be placed at or near the location where the task is to be performed before the preset time. When the preset time has arrived, one or more of a sound-generating component 350 or a light-emitting component 360 may be activated. Sounds and/or light may be generated/emitted in order to attract the attention of the user. At block 620, whether a user mechanical input component 340 is actuated within a predetermined time period after the preset time may be determined, wherein an actuation of the user mechanical input component within the predetermined time period indicates task completion, and an absence of actuation of the user mechanical input component within the predetermined time period indicates task failure. At block 630, a signal indicative of either task completion or task failure based on the determination may be transmitted to the first device 110. The signal indicative of either task completion or task failure may also be transmitted to a third device 130.

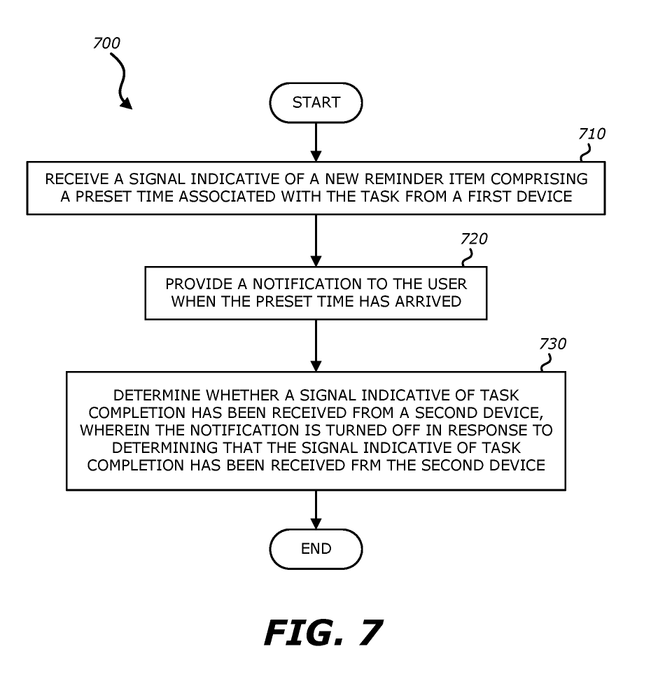

Referring to FIG. 7, a flowchart illustrating an example method 700 for reminding a user to perform a task is shown. The method 700 may be implemented at a third device 130. At block 710, a signal indicative of a new reminder item comprising a preset time associated with the task may be received from a first device 110. A description of the task to be performed at the preset time and/or a location where the task is to be performed may also be included in the new reminder item. The third device may be carried around by the user. At block 720, a notification may be provided to the user when the preset time has arrived. The notification may comprise one or more of: a textual and/or graphical display at a display component 440 of the description of the task to be performed and/or the location where the task is to be performed, a sound generated by a sound-generating component 450, and/or light emitted by a light-emitting component 460, and/or vibration by the third device 130 generated with the vibration component 470. At block 730, it may be determined whether a signal indicative of task completion has been received from a second device 120, wherein the notification may be turned off in response to determining that the signal indicative of task completion has been received from the second device 120.

Therefore, one embodiment of the disclosure is related to a first device 110 comprising a memory 220 and a processor 210 coupled to the memory 220, the processor 210 to: receive user input indicative of a new reminder item comprising a preset time associated with the task; transmit a signal indicative of the preset time associated with the task to a second device; receive a signal indicative of either task completion or task failure from the second device; and transmit a message indicative of either task completion or task failure consistent with the signal to a predetermined recipient.

Therefore, one embodiment of the disclosure is related to a second device 120 comprising a memory 320 and a controller 310 coupled to the memory 320, the controller 310 to: receive a signal indicative of a new reminder item comprising a preset time associated with the task from a first device; determine whether a user mechanical input component is actuated within a predetermined time period after the preset time, wherein an actuation of the user mechanical input component within the predetermined time period indicates task completion, and an absence of actuation of the user mechanical input component within the predetermined time period indicates task failure; and transmit a signal indicative of either task completion or task failure based on the determination to the first device, wherein the second device is placed at or near a location where the task is to be performed before the preset time.

Therefore, one embodiment of the disclosure is related to a third device 130 comprising a memory 420 and a controller 410 coupled to the memory 420, the controller 410 to: receive a signal indicative of a new reminder item comprising a preset time associated with the task from a first device; provide a notification to the user when the preset time has arrived; and determine whether a signal indicative of task completion has been received from a second device, wherein the notification is turned off in response to determining that the signal indicative of task completion has been received from the second device, and wherein the third device is carried around by the user.

Therefore, by utilizing a second device that is placed at or near the location where the task is to be performed and conditioning the dismissal of the reminder item on a physical actuation of a user mechanical input component of the second device, the user is compelled to move to the location when the preset time arrives. Therefore, the likelihood of the task being performed may be increased. Various means, such as sound, light, textual/graphical display, and/or vibration are utilized to attract the attention of or provide notification to the user. Task completion and task failure may be transmitted to a predesignated third party, such as a caretaker or a doctor, such that the task performance may be monitored by a third party.

Various implementations of a method for reminding a user to perform a task have been previously described in detail. It should be appreciated that application or system that various operations of the first, second, and third devices may be implemented as software, firmware, hardware, combinations thereof, etc. In one embodiment, the previous described functions may be implemented by one or more processors (e.g., processor 210 of a first device 110, controller 310 of a second device 120, controller 410 of a third device 130) to achieve the previously desired functions (e.g., the method operations of FIGS. 5-7). Each of the first, second, and third devices in connection with one or more other devices may provide various useful functions, as have been described in detail above.

While particular embodiments have been described in the specification and illustrated in the drawings, it will be understood by those skilled in the art that various changes may be made and equivalents may be substituted for elements thereof without departing from the scope of the invention as defined in the claims. In addition, many modifications may be made to adapt a particular situation or material to the present teachings without departing from the essential scope thereof. Therefore, it is intended that the present teachings are not be limited to the particular embodiments illustrated by the drawings and described in the specification, but that the present teachings will include any embodiments falling within the foregoing description and the appended claims.

What is claimed is:

1. A method for reminding a user to perform a task implemented at a first device, comprising:
receiving user input indicative of a new reminder item comprising a preset time associated with the task;
transmitting a signal indicative of the preset time associated with the task to a second device;
receiving a signal indicative of either task completion or task failure from the second device; and
transmitting a message indicative of either task completion or task failure consistent with the signal to a predetermined recipient.

2. A method for reminding a user to perform a task implemented at a second device, comprising:
receiving a signal indicative of a new reminder item comprising a preset time associated with the task from a first device;
determining whether a user mechanical input component is actuated within a predetermined time period after the preset time, wherein an actuation of the user mechanical input component within the predetermined time period indicates task completion, and an absence of actuation of the user mechanical input component within the predetermined time period indicates task failure; and
transmitting a signal indicative of either task completion or task failure based on the determination to the first device,
wherein the second device is placed at or near a location where the task is to be performed before the preset time.

3. A method for reminding a user to perform a task implemented at a third device, comprising:
receiving a signal indicative of a new reminder item comprising a preset time associated with the task from a first device;
providing a notification to the user when the preset time has arrived; and
determining whether a signal indicative of task completion has been received from a second device, wherein the notification is turned off in response to determining that the signal indicative of task completion has been received from the second device,
and wherein the third device is carried around by the user.
